(19) United States
(12) Patent Application Publication
(10) Pub. No.: US 2013/0154594 A1
(43) Pub. Date: Jun. 20, 2013

(54) ELECTRONIC DEVICE AND METHOD FOR POWER MEASUREMENT

(71) Applicants: Johann Zipperer, Unterschleissheim (DE); Peter Weber, Allershausen (DE)

(72) Inventors: Johann Zipperer, Unterschleissheim (DE); Peter Weber, Allershausen (DE)

(73) Assignee: Texas Instruments Incorporated, Dallas, TX (US)

(21) Appl. No.: 13/329,073

(22) Filed: Dec. 16, 2011

(51) Int. Cl. G05F 1/10

(52) U.S. Cl. 323/282

(57) ABSTRACT

The invention relates to an electronic device comprising a switched mode power converter comprising a switched transistor, an inductor and an error amplifier. The switched transistor is configured to switch a current through the inductor. The error amplifier is configured to control the switching of the switched transistor to convert a primary voltage applied at the input into a secondary voltage at the output of the switched mode power converter. The electronic device further comprises an oscillator, a control logic stage and a digital counter. The control logic stage is coupled to receive a clock signal from the oscillator and to generate switching signals for the switched transistor in form of ON-time pulses with a constant ON-time according to a pulse density scheme. The counter is configured to count the number of ON-time pulses for determining the consumed power based on the number of ON-time pulses per time.

### FIELD OF THE INVENTION

The invention relates to an electronic device and a method for measuring a power consumption, and more specifically to an electronic device and a method for determining a power consumption in a switched mode power converter.

### BACKGROUND

Reducing power consumption is one of the main targets in the development and improvement of all kinds of electronic devices, in particular if they are mobile or portable. In order to save power, electronic devices are more and more controlled accordance with sophisticated schemes in which the magnitude of the consumed currents varies over several decades of magnitude. In low power modes some hundreds of nA of a current may be consumed while other operation modes require up to several hundreds of mA. It is therefore necessary to measure these currents over the whole range with an acceptable accuracy while being able to track fast current changes. Furthermore, any tools or circuitry for measuring the power consumption should occupy only little space in the electronic device and be available for a comparatively low price. Furthermore, any side effects of measuring the consumed power should be avoided, as, for example an influence on specific parameters or an increase of the power consumption due to the power measurement itself.

One of the most common techniques for measuring a current is a measurement using a shunt device or a shunt resister. Using a shunt device for the power measurement requires very high precision analogue to digital converters in order to cover the full dynamic range of the possible magnitudes of the currents. For example, for four and a half decades with one percent precision, a 24-Bit-converter would be required. Furthermore, shunt devices generate a voltage drop. This voltage drop has to be compensated, while the compensation circuitry constitutes a potential source for errors. A direct load compensation is rather difficult if not impossible over multiple decades of dynamic range of the current to be measured. This means that the measurement range and therefore the circuitry used for measuring the power consumption has to be adapted during the power measurement procedure. This increases complexity and entails more potential errors. Still further, measuring a current indirectly by measuring the voltage across a shunt device requires an initial voltage change on the target. If a buffer capacitor is coupled to the target side (output side of a power converter), the buffer capacitor delivers current immediately and needs to be recharged. This behavior affects the true current response of the device under test.

Another approach of measuring the power consumption employs a current mirror. One side of the current mirror delivers the current to the target including the target capacitor. The other side of the current mirror is coupled to an Ampere meter to which the mirrored current is fed. This approach has the advantage that the distortion caused by the target capacitor is minimized. However, the required sense field effect transistors (FET) are rather expensive and the available current ranges are usually larger than required for low power measurements.

Another approach uses pulse width modulation estimation in switched mode power converters. According to this approach, the pulse width of the control signal is applied to a switch in the switched mode power converter is evaluated and the power consumption is estimated based on the determent pulse width. The advantage of this approach is that a rather wide measurement range can be covered. However, the accuracy of this method is rather low due to the non-linear behavior of the transfer function of the components.

### SUMMARY

It is an object of the invention to provide an electronic device and a method for measuring a power consumption in a switched mode power converter that covers a large range of magnitudes of a current to be measured and does not affect the basic functionality of the circuit.

According to an aspect of the invention, an electronic device is provided that comprises a switched mode power converter. The switched mode power converter comprises a switched transistor, an inductor and an error amplifier. The switched transistor is configured to switch a current through the inductor and the error amplifier is configured to control the switching of the switched transistor in order to convert a primary voltage applied at an input of the switched mode power converter into a secondary voltage at the output of the switched mode power converter and to control the level of the secondary voltage. The electronic device further comprises an oscillator, a control logic stage and a digital counter. The control logic stage is coupled to receive a clock signal from the oscillator and to generate switching signals for the switched transistor in form of ON-time pulses with a constant ON-time. The switching signals are formed according to a pulse density scheme. The counter is then configured to count the number of ON-time pulses for determining the consumed power based on the number of ON-time pulses per time. The electronic device according to this aspect of the invention uses a switched mode power converter which operates in an unconventional mode. Due to the constant width of the ON-time pulses, the influence of the non-linear behavior of the switched transistor can be neglected. Any remaining target voltage offset at the output of the switched mode power converter is avoided. The distortion of the current transfer function caused by the target capacitor is reduced and a wide range of magnitudes of the measured current can be covered.

According to another aspect of the invention, the electronic device comprises a first capacitor coupled to the input of the switched mode power converter and a second capacitor coupled to the output of the switched mode power converter. The ON-time of the switched transistor is configured to keep the charge supplied during each ON-time pulse through the switched transistor at least a factor of hundred lower than the charge on the first capacitor and the second capacitor. Since a pulse density scheme is used instead of a pulse width modulation scheme for switching the switched transistor, the frequency of the ON-time pulses is proportional to and practically a linear function of the consumed current. During a stable operation condition, in which the input and output voltages and the charges on the input and output capacitors have settled, each ON-time pulse of the switched transfers about the same amount of the charge (energy).

According to an embodiment of the invention, a reference impedance or a reference resistor can be coupled to the output of the switched power converter in order to make a reference measurement. The results of the reference measurement can then be used for calibrating/normalizing the energy and/or power consumption. Therefore, the count of the ON-time pulses can be used for determining the power consumption during normal operation even with unknown load.

The invention also provides a method of measuring a power consumption of an electronic device. The electronic device comprises a switched mode power converter with a switched transistor and an inductor. The switched transistor can then be configured to switch a current through the inductor and the error amplifier is configured to control the switching of the switch transistor in order to convert a primary voltage apply to the input of the switched mode power converter into a secondary voltage at the output of the switched mode power converter. The error amplifier serves to maintain a stable output voltage. The switched transistor can then be switched using pulses with a constant ON-time. The frequency of the ON-time pulses can be controlled in response to a change of the output voltage (in response to an output of the error amplifier). The frequency of the ON-time pulses can then be determent. This means that the On-time pulses are counted as a function of the time. The power consumption may then be determent based on the frequency of the ON-time pulses.

In an aspect of the invention, the power consumption may then be derived from a phase variation of the ON-time pulses. This aspect allows a quick evaluation of changes of the power consumption.

The charge transfer through the switched transistor during ON-time pulses can then be at least a factor of hundred smaller than a charge stored on a first capacitor coupled to the input of the switched mode power converter and a charge stored on a second capacitor coupled to the output of the switched mode power converter. In another embodiment the charge of each ON-time pulse can be a factor of 1000 smaller then the charge on each capacitor.

The power consumption may be calibrated by coupling a reference impedance to the output of the switched mode power converter. The result of the calibration may then be used for normalizing the power consumption during normal operation. During normal operation a target device or a device under test (DUT) is then coupled to the output of the switched mode power converter instead of the reference impedance. However, in another embodiment, the reference impedance may be coupled to the output while the target load device or DUT is still coupled to the output of the switched mode power converter. The change of the ON-time pulse density (per time) or the a change of the frequency due to the additional load of the reference load can be evaluated for calibrating the power measurement based on the frequency or phase of the ON-time pulses.

### BRIEF DESCRIPTION OF DRAWINGS

Further aspects and characteristics of the invention ensue from the following description of the preferred embodiments of the invention with reference through the accompanying drawings, wherein

FIG. 1 is a simplified circuit diagram of an embodiment of the invention, and

FIG. 2 is a diagram showing waveforms of signals of the circuit shown in FIG. 1.

### DETAILED DESCRIPTION OF EXAMPLE EMBODIMENTS

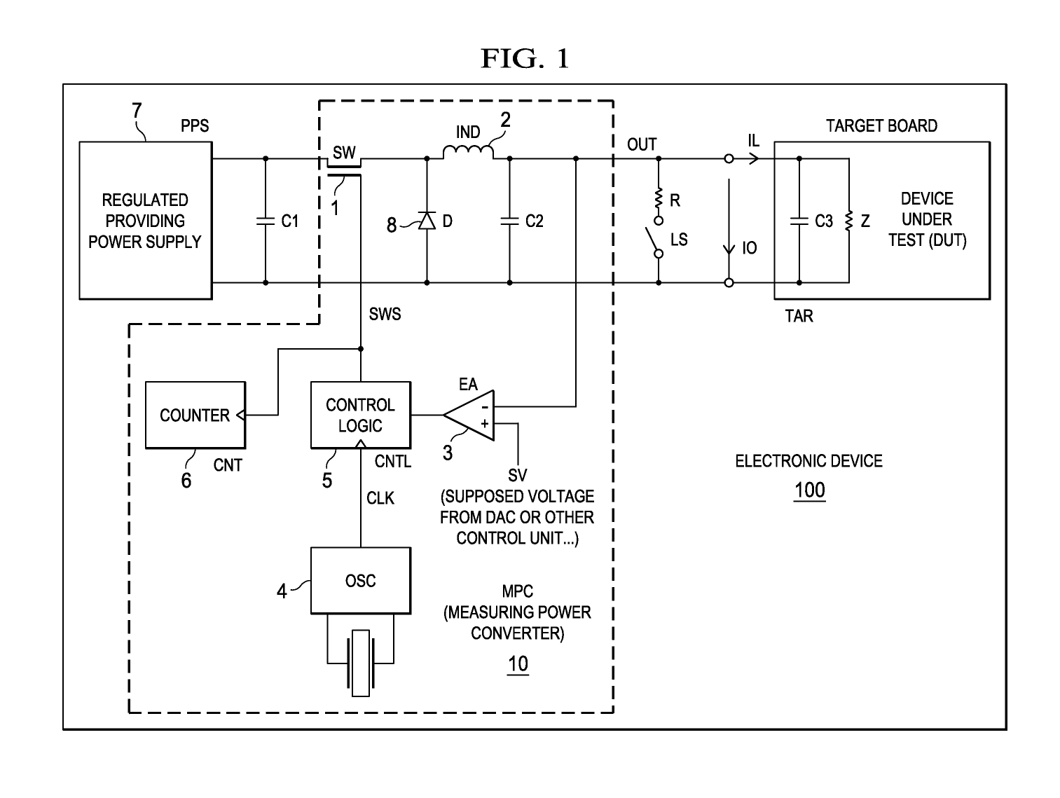

FIG. 1 shows a simplified diagram of an embodiment of the invention. There is an electronic device 100 comprising a switched mode power converter in accordance with aspects of the invention. The switched mode power converter is configured as a measuring power converter MPC 10. The measuring power converter MPC 10 includes a switched transistor SW 1. There is further an inductor IND 2 and an error amplifier EA 3. A diode D 8 is coupled in forward direction between ground and the node between the switch transistor SW 1 and the inductor IND 2. The inductor IND 2 is coupled with one side to the switched transistor SW 1 and with the other side to the output node OUT. The switched transistor can be referred to as energizing switch. The diode D 8 can be replaced by another switch.

There is also a control logic CNTL 5 and an oscillator OSC 4. A counter CNT 6 is coupled to the control logic stage CNTL 5 in order to receive the switching signal SWS that is fed to the control gate of the switched transistor SW 1. The error amplifier EA 3 is coupled with an inverted input to the output OUT of the switched mode power converter 10. The non-inverted input of the error amplifier EA 3 is coupled to receive an external reference signal SV for determining a deviation of the output voltage VO at node OUT. The output of the error amplifier is coupled to the control logic stage CNTL 5. The oscillator OSC 4 is coupled to feed a clock signal CLK to the control logic stage CNTL 5. The control logic stage CNTL 5 provides a switching signal SWS with constant ON-time pulses for switching the switched transistor SW 1. The frequency of the ON-time pulses is a function of the output signal of the error amplifier EA 3. The constant ON-time period is generated with the constant clock signal CLK received from the oscillator OSC 4. The oscillator OSC 4 can be a crystal oscillator. The primary side of the switched mode power converter is coupled to a first capacitor C1. Accordingly, one side of the switched transistor SW 1 is coupled to one side of the first capacitor C1. The other side of the first capacitor C1 is coupled to ground. The primary side of the switched mode power converter MPC 10 is supplied by a regulated providing power supply PPS 7. The output or secondary side of the switched mode power converter MPC 10 is coupled to a second capacitor C2 for buffering the output voltage at node OUT. A target board or device under test can be coupled to the output of the switched mode power converter. The current consumed by the target board or device under test is the load current IL. The level of the output voltage is VO.

A reference impedance in form of a reference resistor R can be coupled through switch LS to the output. During a reference measurement for calibrating/normalizing the power measurement, the target board or device under test may not coupled to the output OUT of the switched mode power converter MPC 10. Instead of the target board the reference resistor R can be switched to the output OUT. However, the target board or DUT may still be coupled to the output during the reference measurement. The result of the reference measurement with the well characterized reference resistor can then be used to calibrate the measurement for the operation with the unknown load of the target board or a DUT.

The charge or energy transferred through the switched transistor SW during an ON-time pulse is much smaller then the charge or energy stored on the capacitors C1 and C2. If the charge that is transferred during an ON-time pulse is CHSW, and the charge on capacitor C1 is CHC1, and the charge on capacitor C2 is CHC2, the following advantageous ratios can be chosen:

CHSW=K1*CHC1 and CHSW=K2*CHC2

with

k1 and k2>100 or

k1 and k2>1000.

CHSW is much smaller than CHC2 and CHC1. As know by the skilled artisan, the charges can be converted into energy values.

When the output voltage OUT has settled, the error amplifier EA 3 measures any deviation from the target output voltage VO and prompts the control logic CNTL 5 to increase or decrease the density of ON-time pulses. The ON-time pulses are generated with a constant duration. The inductor IND 2 receives a certain amount of energy (current) from the first capacitor C1 and transfers this energy to the second capacitor C2 in form of a certain amount of charge (i.e. a certain current during the ON-time pulse). The first capacitor C1 and the second capacitor C2 are dimensioned such that this transfer of charge does not significantly change the voltages across the first capacitor C1 and the second capacitor C2. As long as the charge on the second capacitor C2 is sufficient to maintain the output voltage VO at the output node OUT, the error amplifier EA 3 will not prompt control logic stage CNTL 5 to issue another ON-time pulse through switching signal SWS to switch transistor SW 1. However, if a certain load current IL is consumed by the target board or DUT, the voltage across the second capacitor C2 is reduced until the error amplifier EA 3 determines that the output voltage VO at output node OUT is lower than indicated by the reference signal SV. Another ON-time pulse will then be generated. During normal operation, this causes a pulse density of ON-time pulses of signal SWS that is proportional to the consumed current of the DUT/target board. The number of ON-time pulses per time counted by the counter CNT 6 reflects and indicates the power consumption if it is divided by the observation time (the frequency is determined) and the output voltage VO. Under stable input and output voltage conditions, each ON-time pulse represents the same amount of energy that is transferred during each ON-time pulse. Even the phase variations of the ON-time pulses of the switching signal SWS indicate current variations of the load currents IL.

A reference measurement on the known reference resistor R can be used for normalizing the measured current. The reference resistor R may be switched on through switch LS in addition to the target board. The influence of the reference resistor on the frequency of the ON-time pulses in signal SWS can then be evaluated. However, the achieved result can be improved if the reference resistor R is switched on while the target board is not connected.

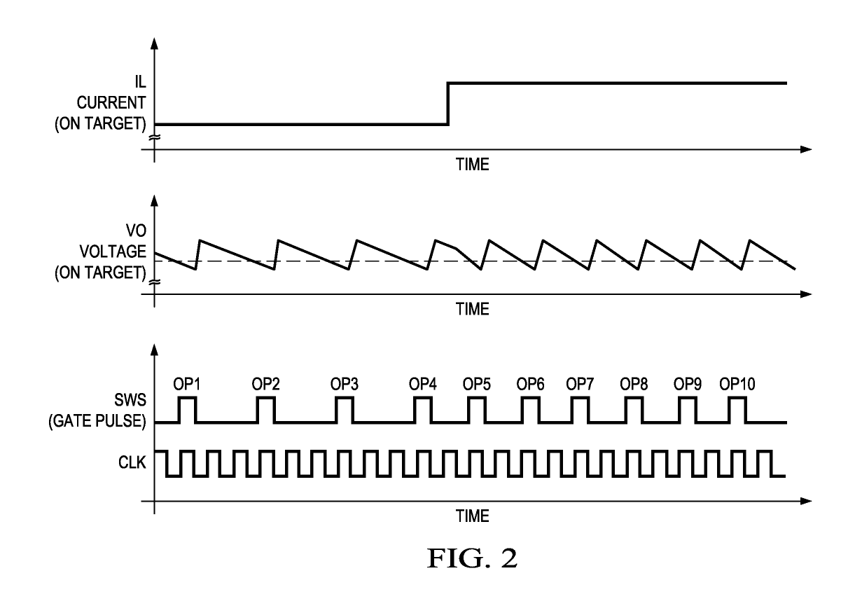

FIG. 2 shows a simplify diagram with waveforms of the load current IL, the output voltage VO and the switching signal SWS as well as the clocks signal CLK. The load current IL consumed by the target or device under test increases at a certain point of time. The voltage VO at the output node OUT varies according to a saw tooth scheme around the target output voltage level (dashed line). The pulse density of the ON-time pulses OP1 to OP10 increases (i.e. the frequency of the ON-time pulses OP1 to OP10 increases) after the load current IL increases. This change of frequency (or density) of ON-time pulses is evaluated.

Although the invention has been described hereinabove with reference to a specific embodiments, it is not limited to these embodiment and no doubt further alternatives will occur to the skilled person that lie within the scope of the invention as claimed.

1. An electronic device comprising a switched mode power converter comprising a switched transistor (SW), an inductor (IND), an error amplifier (EA), the switched transistor being configured to switch a current through the inductor and the error amplifier being configured to control the switching of the switched transistor in order to convert a primary voltage applied at an input of the switched mode power converter into a secondary voltage at an output of the switched mode power converter, wherein the electronic device further comprises an oscillator (OSC), a control logic stage (CNTL) and a digital counter (CNT) wherein the control logic stage is coupled to receive a clock signal from the oscillator and to generate switching signals for the switched transistor in form of ON-time pulses with a constant width ON-time according to a pulse density scheme, and wherein the counter is configured to count a number of ON-time pulses for determining a consumed power based on the number of ON-time pulses per time.

2. The electronic device according to claim 1, further comprising a first capacitor coupled to the input of the switched mode power converter and a second capacitor coupled to the output of the switched mode power converter, and wherein the ON-time of the switched transistor is configured so as to keep a charge supplied during each ON-time pulse through the switched transistor at least a factor of hundred lower than the charge on the first capacitor and the second capacitor.

3. The electronic device according to claim 2, the charge supplied during each ON-time pulse through the switched transistor is at least a factor of hundred lower than the charge on the first capacitor and the second capacitor.

4. The electronic device according to claim 3, wherein the electronic device further comprises a reference resistor that is configured to be coupled to the output of the switched mode power converter for normalizing an energy and or power determined based on a count of the pulses per time.

5. A method of measuring a power consumption of an electronic device that comprises a switched mode power converter comprising a switched transistor (SW) and an inductor (IND), the switched transistor being configured to switch a current through the inductor and an error amplifier being configured to control the switching of the switched transistor in order to convert a primary voltage applied at an input of the switched mode power converter into a secondary voltage at an output of the switched mode power converter, the method comprising the steps of: switching the switched transistor with pulses having a constant width ON-time, controlling the frequency of ON-time pulses in response to a change of an output voltage determined by the error amplifier, determining a frequency of ON-time pulses and determining the power consumption based on the frequency of the ON-time pulses.

6. The method according to claim 5, wherein the power consumption is derived from a phase variation of the ON-time pulses.

7. The method according to claim 5, wherein a charge transferred through the switched transistor during an ON-time pulse is at least a factor of hundred smaller than a charge stored on a first capacitor coupled to the input of the switched mode power converter and a charge stored on a second capacitor coupled to the output of the switched mode power converter.

8. The method according to claim 7, further comprising the step of calibrating the power consumption by coupling a reference impedance to the output of the switched mode power converter.
